(19) United States
(12) Patent Application Publication
(10) Pub. No.: US 2013/0036141 A1
(43) Pub. Date: Feb. 7, 2013

(54) SATELLITE ADDRESSING CONCEPT

(71) Applicant: Gholam Hossein Rastegar, Brigadoon (AU)

(72) Inventor: Gholam Hossein Rastegar, Brigadoon (AU)

(21) Appl. No.: 13/635,691

(22) PCT Filed: Oct. 11, 2010
(86) PCT No.: PCT/AU2010/001338

§ 371 Date: Sep. 18, 2012

(30) Foreign Application Priority Data
Apr. 22, 2010 (AU) 2010901701
Jul. 5, 2010 (AU) 2010202686

(51) Int. Cl. G06F 17/30; G06F 17/00

(52) U.S. Cl. 707/783; 715/256; 707/E17.005

(57) ABSTRACT

A method of using latitude and longitude coordinates of a point as a means to specify a unique and unmistakable destination address. These coordinates are not affected by changes in street numbering, changes in street names, and these coordinates are never out-dated nor do they require updating or upgrading. Some examples of where the latitude and longitude coordinates can be displayed are on items such as business cards, letterheads, directories, advertisements, billboards and websites.

This invention relates to a process and/or concept which may be used to further enhance the means and methods currently available in the market for anyone to reach a physical point of destination. The said process and for concept is for use by absolutely anybody to either pinpoint the exact location of their target destination or for absolutely anybody to facilitate a very convenient and accurate means of ensuring their respective intended location is pinpointed by absolutely anybody who wishes to pinpoint their exact location. The application of the said process and or concept includes but not limited to use, for business purposes, for recreational purposes, for personal purposes and for use as an effective marketing tool.

In order for anyone whether individual, an organisation, a government department and/or a business to enable others to pinpoint its location and reach its intended physical target, traditional methods of providing the street address, postal address, PO Box, Post code and/or zip code are the most commonly used methods. Also, in order for anyone to locate and find a desired physical target location the use of street directories, Maps and/or Satellite NaVigation Systems are by far the most commonly used methods. Whilst these are effective and reliable methods of indicating, pinpointing and finding the desired target locations, there are inherent weaknesses in all these methods.

In highly competitive markets of today, it is essential for individuals, businesses and/or organisations private or otherwise to make themselves more readily and easily accessible to potential clients. It is even more crucial for retail businesses to do whatever possible to make sure their customers are able to locate their premises, offices, stores, factories or their places of business, easily, rapidly and without wasting valuable time. In today's business environment, all other things being equal, the speed with which a product or service is delivered and/or is made accessible and available to the end user is of paramount importance and more often than not this can be and is the deciding factor for the end user. Following the same principle, the ease with which a potential customer can locate the place of business which provides the desired product or service is a major contributing factor to successful completion of the business transaction between that supplier and its customer.

Equally important, if not more, is the need for emergency services to be able to reach the location where the emergency assistance is needed as quickly as possible. It is also very important to introduce enhance methods to improve the ability of anyone who needs to reach an emergency service point such as a hospital, a medical clinic, a police station and/or suchlike to accurately pinpoint and reach such desired location with ease and fast.

Conventional methods currently utilised to locate business premises, homes, government departments, hospitals and or any other places of interest are workable but not perfect and for a number of reasons, referred to in the paragraphs to follow, there exists a reasonable probability that the target location is not found or not found with ease. Street numbering system is subject to change, street names may change, Maps, Street Directories and Satellite Navigation data bases can become out-dated and would need to be regularly up-dated or new data up-loaded, all of which can give rise to the said probability of not finding the target location. This, at best could result in loss of business and at worst could result in loss of life in the cases whereby emergency services are not located in time or the emergency services could not reach the intended location of the recipient of require services in time.

The present invention differs from such conventional methods in so far as it relies on using latitude and longitude coordinates of the point as a mean to specify a unique destination point and or address. These coordinates are not affected by changes in street numbering system nor can they be affected by any change in street name, it is never out-dated nor does it require updating or upgrading.

1-10. (canceled)

11. An addressing display method comprising of the notation of latitude and longitude information of a location on documents, advertising material, business directories or websites as a mean to indicate a physical location.

12. An addressing display method according to claim 11, wherein the phrase “SatAdd” is used to denote the latitude and longitude information.
For example, SatAdd: S32°06.485′ E1 15°49.179′

13. Displaying, printing, etching, engraving by any method and/or otherwise showing of the identified, specific and unique latitude and longitude Coordinates as claimed in claim 11, including on Business Cards, Letterheads, in Telephone Directories, Business Directories, Advertisements, Public or private Media (print audio and/or visual), Billboards, Promotional Material, Websites and/or any other documents, material and/or places where ordinarily and commonly telephone numbers, facsimile numbers, email addresses, postal addresses and/or street addresses are displayed, printed, etched, engraved by any method and/or otherwise shown.

14. The uploading, entering, and/or by any other method storing of the specific and unique latitude and longitude Coordinates as claimed in claim 11, for the required location in a Global Positioning System device such as a Satellite Navigation System or Mobile Telephone System equipped with GPS services or any other similar system and/or device whether automated or manual function upon which the system can and or may be used to guide the users and lead them to the exact target location without having to enter the street no, street name, suburb or other information in the device.

15. An addressing display method according to claim 11, wherein the latitude and longitude information is displayed in bar code or other recognised coded format.

16. The development, supply and or use of all methods and devices wherein the latitude and longitude information is displayed in bar code or other recognised coded format and all GPS Service Devices as claimed in claim 14.

17. An addressing display method according to claim 11, wherein the latitude and longitude information is displayed in an encrypted phrase, shape or logo format.

18. An addressing display method according to claim 11, wherein the latitude and longitude information are entered and stored in a password protected secure web- based data bank.

19. A password protected secure web-based data bank according to claim 11, wherein the latitude and longitude information is decrypted to a format which can be uploaded and recognised by GPS apparatus.

20. A password protected secure web-based data bank according to claim 11, wherein the latitude and longitude information along with other desired information for all subscribers are stored and all subscribers can access the information on the data bank by using their individually assigned user names and passwords.
